(19) United States
(12) Patent Application Publication
(10) Pub. No.: US 2022/0361405 A1
(43) Pub. Date: Nov. 17, 2022

(54) SYSTEM AND METHOD DETERMINING WHETHER TO GRIND CHOPPING BLADES OF A CHOPPING DEVICE

(71) Applicant: CLAAS Selbstfahrende Erntemaschinen GmbH, Harsewinkel (DE)

(72) Inventors: Christoph Heitmann, Warendorf (DE); Dennis Neitemeier, Lippetal (DE); Markus Brune, Harsewinkel (DE); Patrick Hinz, Greffen (DE)

(73) Assignee: CLAAS Selbstfahrende Erntemaschinen GmbH, Harsewinkel (DE)

(21) Appl. No.: 17/740,795

(22) Filed: May 10, 2022

(30) Foreign Application Priority Data
May 17, 2021 (DE) 102021112650.9

(51) Int. Cl. A01D 43/08; G01N 21/88

(52) U.S. Cl. CPC A01D 43/085; G01N 21/8851

(57) ABSTRACT

A method and a self-propelled forage harvester for determining the need for grinding chopping blades of a chopping device of the self-propelled forage harvester is disclosed. A monitoring device determines, such as cyclically, the state of wear of the chopping blades. The monitoring device comprises an input/output unit through which to enter or select a target state of the chopping blades to be produced by a grinding device as a target. The monitoring device generates, such as continuously, information depending on the target state and the determined state of wear, and causes an output on the input/output unit to visualize the extent to which the currently determined state of wear deviates from the target state.

### CROSS REFERENCE TO RELATED APPLICATIONS

This application claims priority under 35 U.S.C. § 119 to German Patent Application No. DE 102021112650.9 filed May 17, 2021, the entire disclosure of which is hereby incorporated by reference herein.

### TECHNICAL FIELD

The invention relates to a self-propelled harvester and a method for determining whether to grind chopping blades of a chopping device for a self-propelled harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A monitoring device may cyclically determine whether to (e.g., a need for) grinding chopping blades of a chopping device of a self-propelled forage harvester based on a state of wear. For example, EP 2 008 508 B1 describes a forage harvester having a camera for generating images of the cutting edges of chopping blades of a chopping device. The images are displayed on a monitor in a driver's cab of the forage harvester and evaluated by an operator with respect to the quality of the chopping edges. With reference to irregularities over the course of the chopping edge, the operator determines whether an additional grinding process is needed to achieve the desired edge sharpness.

EP 2 225 931 B1 discloses a forage harvester and a method for determining the need to grind chopping blades, according to which a forecast of the expected wear is derived by using harvested material parameters (e.g., the type of harvested material) and machine parameters (e.g., the harvested material throughput and length of cut).

EP 3 738 429 A1 (US Patent Application No. 2020/0363184, incorporated by reference herein in its entirety) discloses a driver assistance system for a forage harvester, wherein the state of wear of chopping blades is determined by a monitoring device, and the distance of the chopping blades to the shear bar is determined by a target/actual comparison. From the determined state of wear or the determined distance of the chopping blades to the shear bar, a forecast of the state of wear of the chopping blades, or a forecast of the state of the shear bar, is generated from which the automatic estimation of the point in time to perform a grinding process is based. The number of grinding cycles to be performed may also be forecast in order to then forecast a suitable point in time so as not to interrupt the performance of the ongoing harvesting process by performing the grinding process. Via an output on the display, the driver assistance system informs the operator that one or more chopping blades has fallen below a threshold value for the chopping edge sharpness. Then, the operator may decide when a grinding process of the chopping blades should be performed.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 shows a schematic representation of a forage harvester.

FIG. 2 shows a detailed view of the forage harvester according to FIG. 1.

FIG. 3 shows a schematic representation of a monitoring device of the forage harvester.

FIG. 4 shows a schematic representation of a control display of an input/output unit of the forage harvester.

### DETAILED DESCRIPTION

As discussed in the background, the operator may be informed that a critical state of wear has been reached; however, without a suitable comparative yardstick or metric, the operator may be left in the dark or lacking as to the specific extent of a grinding process that is to be performed.

Thus, in one or some embodiments, a method and self-propelled forage harvester are disclosed for determining the need to grind chopping blades of a chopping device by informing, in an understandable manner to the operator, about the current state of wear and the resulting effort to perform a grinding process so that the operator may react or may respond more flexibly.

In one or some embodiments, a method is disclosed for determining whether to grind (e.g., the need for grinding) chopping blades of a chopping device of a self-propelled forage harvester. In one or some embodiments, a monitoring device may periodically (such as cyclically) determine the state of wear of the chopping blades. In one or some embodiments, the monitoring device comprises an input/output unit (interchangeably termed input unit/output unit) through which the target state of the chopping blades may be entered or selected. In one embodiment, the input/output unit comprises a single device, such as a touchscreen display. Alternatively, the input/output unit comprises separate devices, one device of which is configured to receive input and serving as the input unit (such as selecting or entering the target state) and the other device of which is configured to generate output and serving as the output unit (such as the visualization). As used herein, the term input/output unit (interchangeably termed input/output device) includes a single device or separate devices. In turn, the target state of the chopping blades may be used by the grinding device, which may grind the chopping blades to the selected or entered target state. Further, the monitoring device may generate information, such as periodically or continuously, indicative of the current state of wear. Moreover, depending on the target state and the determined current state of wear, the input/output unit may visualize both the current state of wear and the target state. The visualization may comprise an indication of a comparison, such as the extent to which the currently determined state of wear deviates from the target state. In this way, an operator may specify the target state by an input or selection that corresponds to her/his requirements for a particular aspect of operating the forage harvester, such as specify the optimum target state of the chopping blades in a specific harvesting situation. The monitoring device then generates, such as continuously generates, information dependent on both the target state and the determined state of wear (e.g., the input/output unit visualizes the extent to which the currently determined state of wear of the chopping blades, hereinafter also termed the actual state, deviates from the target state). In this way, the operator may be provided (such as cyclically provided) with up-to-date information about the deviation of the current state of wear versus the target state. Moreover, in contrast to the prior art, the operator need not subjectively evaluate the actual state of the chopping blades since an indication of the deviation from the actual state versus the target state is provided. This may thus make it easier for the operator to detect the currently required need for grinding to then be able to better plan the grinding processes, such as when changing fields, during service times that occur, filling up, etc.

In one or some embodiments, a cutting sharpness and/or a number of grinding cycles to be performed may be entered or selected as a target state for the chopping blades that, after the number of grinding cycles are performed, achieve the entered or selected cutting sharpness. In one or some embodiments, the cutting sharpness may be entered or selected as an absolute or relative value. In one or some embodiments, the cutting sharpness as the target state of the chopping blade may be specified as a percentage share of the cutting sharpness of a new chopping blade. Alternatively or in addition, a number of grinding cycles may be specified by the operator that are to be performed by the grinding device until the chopping blades have again achieved the entered or selected target state.

In one or some embodiments, the extent of the deviation of the currently determined state of wear from the entered or selected target state may be visualized as an operating parameter of the grinding device. The operator may thereby be made aware, such as continuously or periodically aware, of the state of wear or the actual state of the chopping blades. In particular, the display of an operating parameter by the grinding device as an indicator of the deviation is understandable to the operator since it generally concerns values which are familiar to the operator that make it easier for the operator to be able to estimate the duration and necessity of initiating a regrinding process.

In one or some embodiments, at least one comparative value for the target state to be entered or selected may be displayed by the input/output unit. The comparative value may serve as a guide value or orientation. The specification of the comparative value may be useful during the ongoing operation of the forage harvester, particularly for novice operators. The comparative value may include both manufacturer-specific knowledge and/or empirical knowledge.

The relative and/or absolute cutting sharpness when the chopping blades are in a new state, and/or a target state value adapted and optimized to a specific harvesting situation, may be displayed as a comparative value for selection. The relative and/or absolute cutting sharpness as a comparative value may be determined in a variety of ways, such as by a dialog-based query of the harvesting situation. In so doing, the operator may, for example, specify the type of harvested material. Depending on the type of harvested material, for example when cutting corn or grass, different magnitudes of wear of the chopping blades are tolerated so that the optimized target state value is different (e.g., the optimized target state is higher in the case of corn than with grass). It is also contemplated to additionally query other parameters that may influence the wear of the chopping blades. For example, harvesting under sandy conditions may be a parameter, which may correlate to a specific target state value (e.g., a sandy conditions target state value). With reference to the type of harvested material and additionally by querying certain parameters, the system may retrieve a value from a database saved in a memory unit of the monitoring device of the relative cutting blade sharpness and displayed as a suggestion for the comparative value. In particular, the database may correlate specific harvesting situations and/or specific parameters to specific values of the target state. In practice, responsive to identifying the specific harvesting situation and/or the specific parameter (whether automatically determined or by input from the operator), the system may access the database in order to obtain the respective value of the target state that is correlated to the identified respective specific harvesting situation or identified respective specific parameter.

In one or some embodiments, a measure of the deviation between the current state and the target state may comprise a number of grinding cycles to be performed by the grinding device to achieve the entered or selected target state. In one or some embodiments, the total number of grinding cycles is displayed as an operating parameter of the grinding device by which the currently determined state of wear, as an actual state, differs from the entered or selected target state. The displayed amount may be a positive or negative number of grinding cycles that describe the difference between the current actual state and the selected or entered target state. Accordingly, a positive number of grinding cycles stands for an actual state of the chopping blades that is better than the selected or entered target state. Correspondingly, a negative number of grinding cycles for a current actual state of the chopping blades indicates the deviation from the target state, which also corresponds to the number of grinding cycles to be performed that, after they are performed, yields the target state of the chopping blades selected or entered by the operator. In one or some embodiments, the system may determine the number of grinding cycles by analysis (e.g., by comparing an image of the current state of wear versus an image of the target state to determine a difference, with additional analysis determining the number of cycles based on the difference).

In one or some embodiments, the system may output on the display the number or total grinding cycles as a magnitude of the deviation, which may be understandable to the operator since these are parameters which are familiar to the operator that make it easier for the operator to be able to estimate the duration and necessity of initiating a regrinding process.

In particular, comparative pictures of the state of wear of one or more chopping blades may be displayed by the input/output unit that indicate the currently determined state of wear and picture(s) of a state of wear corresponding to the target state. In addition to the display of the deviation as a number or total of grinding cycles to be performed, the actual state of the chopping blades may be displayed to the operator and compared with the target state. To do this, the operator need not leave the driver's cab of the forage harvester. In one or some embodiments, the operator may be shown, via the display, just one single blade, or several searched blades that is/are completely or entirely damaged. This may be useful when, for example, individual blades have been damaged by foreign bodies. The operator may decide whether or not to exchange the damaged blade. In one or some embodiments, several comparative pictures may be shown on the display, arranged next to each other or over each other by the input/output unit that shows any one, any combination, or all of: the new state of chopping blades; the set or selected target state; another cutting sharpness-specific reference value; or the current actual state.

To display the comparative pictures that reproduce the target state, the comparative pictures may be selected depending on a specification of harvesting parameters and/or machine parameters from a database saved in a memory unit of the monitoring device. As such, the forage harvester, either automatically or via operator input, may determine the harvesting parameters and/or the machine parameters, with the comparative pictures being selected by using the determined harvesting parameters and/or machine parameters to lookup in the database the comparative pictures saved to and correlated to the harvesting parameters and/or the machine parameters.

Moreover, comparative pictures that reproduce the currently determined state of wear may be recorded by an optical detection device that may be assigned to the grinding device. In one or some embodiments, the assignment to the grinding device may be advantageous since the optical detection device (e.g., positioned proximate to the grinding device) may be exposed to the flow of harvested material to a lesser extent than if positioned elsewhere in the flow of harvested material.

Moreover, in one or some embodiments, the input/output unit may comprise a touch-sensitive screen, wherein when selecting a comparative picture by touching the display, one may switch from a window mode to a full image mode or vice versa. This allows details to be better recognized in the comparative pictures given the larger display in the full image mode.

In one or some embodiments, a virtual control field may be displayed by the input/output unit with which the target state may be manually selected. This may, for example, be a control field, thereby designed and configured as a control field, which selects and sets target states saved in the database as a default. In one or some embodiments, these may be manufacturer-specific defaults.

In one or some embodiments, a virtual control element may be displayed by the input/output unit with which the target state is manually selected. To do this, the virtual control element may be designed as a movable or rotatable controller (e.g., a slider or a dial on the touchscreen) that is actuated by the operator in order to enter a specific target state.

In one or some embodiments, the information visualized by the input/output unit may be displayed as any one, any combination, or all of: a numeric value; a column; or a progression over time. In one or some embodiments, the information is shown as a numeric value in a display field by the input/output unit.

In one or some embodiments, an authorization query may be performed before making an entry or selecting the target state. This makes it possible to restrictively handle the settings so that individual operators or definable groups of people are excluded (or only select operators or definable groups of people are included and allowed to select or enter a target state), such as from selecting or entering a target state, or the entry may at least be restricted.

In one or some embodiments, a self-propelled forage harvester is disclosed for use in the disclosed method. Reference is made to all statements herein that are suitable for describing the self-propelled forage harvester per se, or its use.

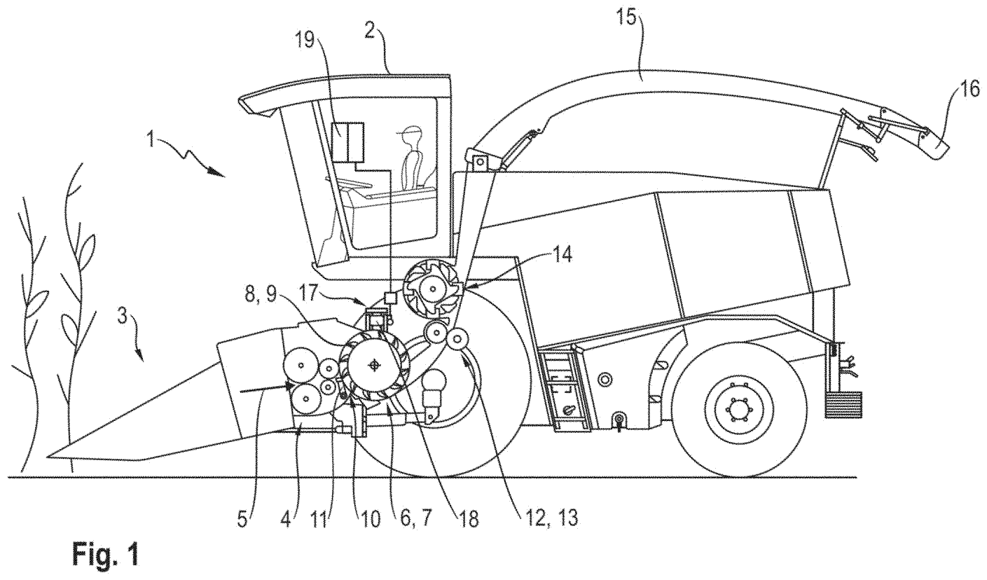

Referring to the figures, FIG. 1 schematically shows a forage harvester 1 with a driver's cab 2 that holds a harvesting header 3 such as a corn picker in its front region. An example of a forage harvester is disclosed in U.S. Pat. No. 11,185,013, incorporated by reference herein in its entirety. So-called infeed and prepress rollers 4 are in, and assigned to, the rear region of the harvesting header 3 that receive a flow of harvested material 5 coming from the harvesting header 1, compress it, and transfer it in its rear region to a chopping device 6. In a manner described in greater detail below, the chopping device 6 comprises a cutterhead 7 that is equipped with chopping blades 8 of a chopping blade assembly 9. The revolving chopping blades 8 are moved past a so-called shear bar 11 in the infeed region 10 of the cutterhead 7 through which the flow of harvested material 5 to be ground is conveyed. In the rear region of the cutterhead 7, the ground harvested material 5 is then transferred either to a regrinding apparatus 13 designed as a so-called cracker 12, or directly to a post-acceleration apparatus 14. While the regrinding apparatus 13 further grinds the particulate components of the flow of harvested material 5 such as corn grains, the post-accelerator apparatus 14 may accelerate the flow of harvested material 5 such that it is moved through a discharge chute 15 and leaves the forage harvester 1 at the end in the region of a discharge flap 16 and may be transferred to a transport vehicle (not shown). Moreover, a well-known grinding device 17 is assigned to the cutterhead 7 on the circumference that will therefore not be described in detail in this context, whose grindstone 18 moves horizontally across the width of the cutterhead 7 to grind each chopping blade 8 positioned on the circumference of the cutterhead 7. To activate or deactivate the blade grinding process, the grinding device 17 may be assigned an input/output unit 19. For example, the computing unit 30, discussed below, may send a command to the grinding device 17 to activate and/or deactivate the blade grinding process, with the computing unit 30 being triggered to send the command(s) in response to input from the input/output unit 19 and/or in response to automatic comparison of one some or each chopping blade 8 to target state value(s).

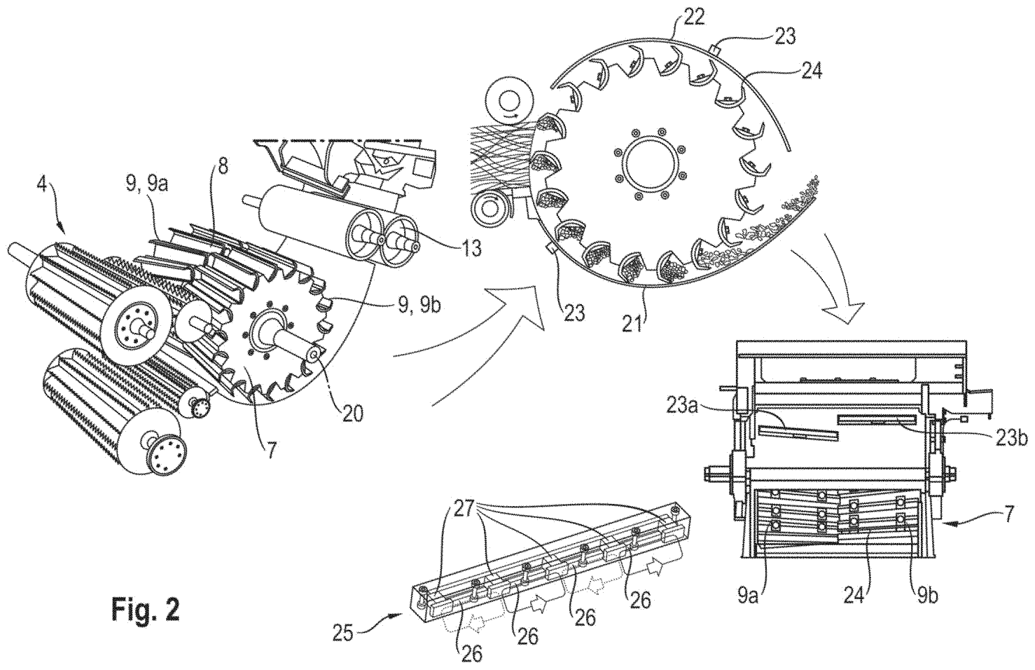

According to FIG. 2, the chopping blade assembly 9 comprises right and left-side chopping blade assemblies 9a, 9b, wherein each chopping blade assembly 9a, 9b comprises a plurality of chopping blades 8 positioned on the circumference of the cutterhead 7 oblique to the axis of rotation 20 of the cutterhead 7. The cutterhead 7 is enclosed at the bottom by a drum bottom 21. At the top, the cutterhead 7 is enclosed by a drum rear wall 22. According to the embodiment illustrated in FIG. 2, the sensor assembly 23 may only be positioned on the drum rear wall 22 or on the drum bottom 21. It is also contemplated to arrange a sensor assembly 23 both on the drum bottom 21 as well as on the drum rear wall 22. Thus, the sensor assembly 23 may be positioned in one or more places. Depending on the position of the sensor assembly 23, the drum bottom 21 and/or the drum rear wall 22 may comprise (or consist of) stainless steel. Independent of the specific position, each cutterhead 7 may be assigned at least two sensor assemblies 23a, 23b such that each one of the sensor assemblies 23a, 23b is assigned to the associated chopping blade assembly 9a, 9b, wherein each sensor assembly 23a, 23b completely covers the cutting edge 24 of the particular chopping blade 8 so that each cutting edge 24 may be detected over its entire length by the particular sensor assembly 23a, 23b. It also contemplated that the particular sensor assembly 23a, 23b may either be positioned parallel to the axis of rotation 20 of the cutterhead 7, or parallel to the cutting edge 24 of the chopping blades 8 on the drum bottom 21 and/or the drum rear wall 22. The illustration on the bottom right in FIG. 2 only shows an example of the potential alignments of the sensor assemblies 23a, 23b in a single illustration. Other alignments are contemplated. In one or some embodiments, all sensor assemblies 23a, 23b are either positioned parallel to the axis of rotation 20 of the cutterhead 7, or parallel to the cutting edge 24 of the chopping blades 8. In the illustrated embodiment, the sensor assemblies 23a, 23b are designed as inductive sensors 25, wherein each sensor assembly 23 comprises one or more magnetic exciter assemblies 26 and a pole arrangement 27 that interacts therewith. Further details on the sensor assemblies for detecting the state of wear of the chopping blades 8 are found in U.S. Pat. No. 10,568,271, the entire disclosure of which is hereby incorporated by reference.

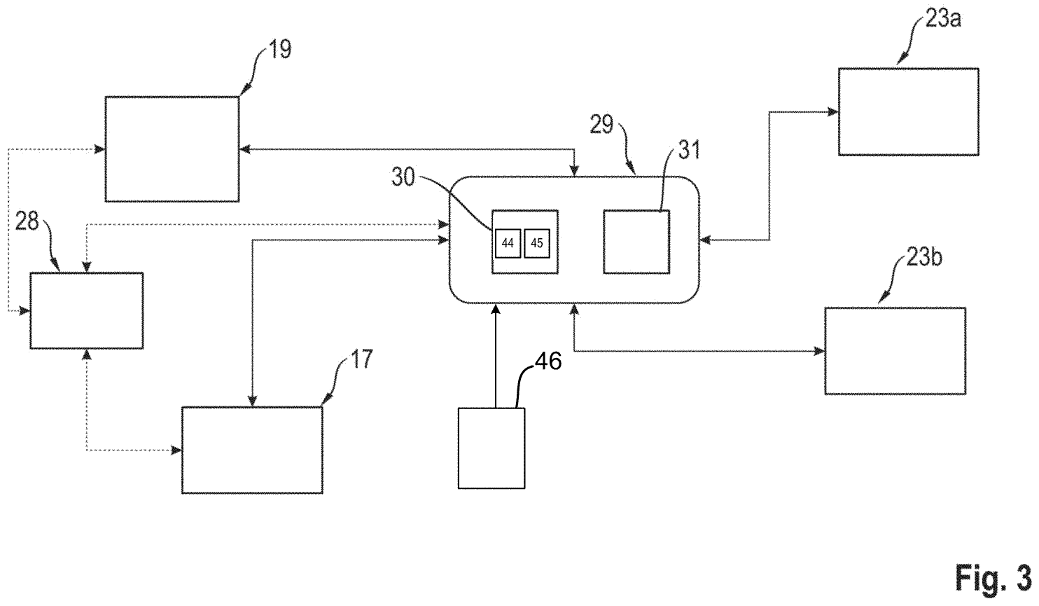

FIG. 3 schematically shows a monitoring device 29 that serves to actuate the grinding device 17. The monitoring device 29 is linked by signals to the grinding device 17, the input/output unit 19, and the sensor assemblies 23a, 23b. The monitoring device 29 comprises a computing unit 30 as well as a memory unit 31. A database among other things may be saved in the memory unit 31. The computing unit 30 may include processing functionality, such as at least one processor 44 and at least one memory 45 to store instructions, such as computer executable instruction stored on a tangible computer readable medium, that when executed by the at least one processor 44 perform the functionality disclosed therein. Computing unit 30 may comprise any type of computing functionality, such as at least one processor 44 (which may comprise a microprocessor, controller, PLA, or the like) and at least one memory 45. The memory 45 may comprise any type of storage device (e.g., any type of memory). Though the processor 44 and memory 45 are depicted as separate elements, they may be part of a single machine, which includes a microprocessor (or other type of controller) and a memory. Though two memories are disclosed in 31 and 45, other memory configurations are contemplated, including a single memory or more than two memories.

The processor 44 and memory 45 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. Computing unit 30, using software (e.g., computer executable instructions for executing the analytical routine) and/or hardware, is configured to perform the functions described herein.

The monitoring device 29 is configured to evaluate the signals provided by the sensor assemblies 23a, 23b from which the current state of wear of the chopping blades 8 may be determined, such as cyclically determined. A target state of the chopping blades 8, for purposes of controlling the grinding device 17, may be established, entered or selected through the input/output unit 19 of the monitoring device 29 as a target specification. The forage harvester 1 may moreover comprise a higher-level control device 28 that serves to actuate one or more working units of the forage harvester 1.

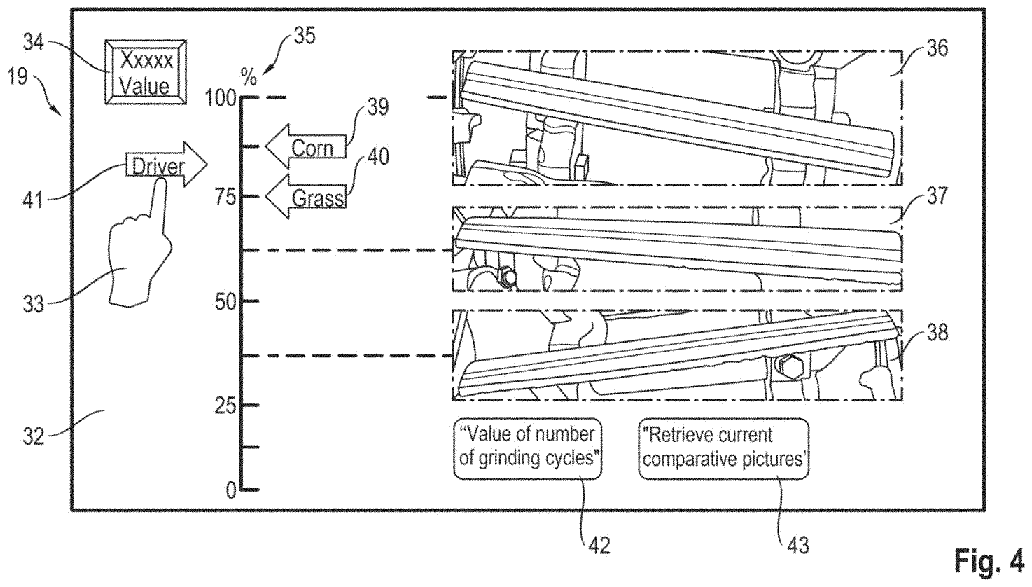

The illustration in FIG. 4 shows a schematic representation of a control display of an input/output unit 19 of the forage harvester 1. The input/output unit 19 comprises a touch-sensitive screen 32. The display shown on the screen 32 reproduces, for example, a setting situation in which an operator 33, symbolized by a hand, may enter (e.g., specify at his own discretion) or select a target state of the cutting sharpness of the chopping blades 8 to be established by the grinding device 17. There are several options for the operator 33 to do this that will be explained below.

In an operating situation in which the operator 33 is uncertain of the target state that he/she will specify, it is possible to select a manufacturer's specified value for a target state by actuating a virtual control field 34. Manufacturer values of the target states for different harvested material parameters and operating parameters such as type of harvested material, harvested material region and/or machine type may be retrievably saved in the memory unit.

A scale 35 shows a relative cutting sharpness of the chopping blades 8. The scale 35 ranges from 0% to 100%. Alternatively or in addition, an absolute value may be displayed for the cutting sharpness of the chopping blades 8. In one or some embodiments, at least one comparative value for the target state to be entered or selected may be displayed by the input/output unit 19. The comparative value may serve as a guide value or orientation. The relative cutting sharpness when the chopping blades 8 are in a new state, and/or a target state value adapted and optimized to a specific harvesting situation, may be displayed as a comparative value. In addition, to help the operator 33 make a selection or entry, a plurality of comparative pictures 36, 37, 38 may optionally be shown that are each assigned different values on the scale 35 for the relative cutting sharpness.

Accordingly, the comparative picture 36 shows a chopping blade 8 in its new state with a relative cutting sharpness of 100%. The following comparative picture 37 shows a chopping blade 8 that already has significant wear and whose relative cutting sharpness lies between 50% and 75%. In the third comparative picture 38, a chopping blade 8 is shown as an example that negatively influences the efficiency of the cutting process given the advanced wear. In particular, the power consumption of the chopping device increases. The attainable cutting quality of the harvested material may also be influenced. For an enlarged display of one of the comparative pictures 36, 37, 38, the display may be switched from a window mode to a full-screen mode or vice versa by touching the particular comparative picture 36, 37, 38.

In particular, comparative pictures of the state of wear of the chopping blades 8 may be displayed by the input/output unit 19 that indicate the currently determined state of wear and a state of wear corresponding to the target state. In addition to the display of the deviation, the actual state of the chopping blades 8 may therefore also be displayed to the operator 33. To do this, the operator 33 need not leave the driver's cab 2 of the forage harvester 1. In one or some embodiments, several comparative pictures 36, 37, 38 may be shown in any one, any combination, or all of: arranged next to each other or over each other by the input/output unit 19 that shows the new state of chopping blades, or the set or selected target state, and/or another cutting sharpness-specific reference value, and/or the current actual state.

Moreover, comparative pictures that reproduce the currently determined state of wear through the monitoring device 29 may be recorded by an optical detection device 46 that in particular may be assigned to the grinding device 17. The assignment to the grinding device 17 is advantageous since the optical detection device 46 is exposed to the flow of harvested material 5 to a lesser extent. These comparative pictures that reproduce the current state of wear may for example be displayed together with a warning to be generated. In addition or alternatively, the operator 33 may retrieve these comparative pictures independently thereof. To do this, for example a virtual control unit 43 (e.g., an icon) designated “Retrieve current comparative pictures” may be displayed in order to display a comparative picture corresponding to the actual state of the chopping blades 8.

When the virtual control field 34 is actuated by the operator 33, a specific value, particularly for the type of harvested material to be processed, may be specified for a target state.

In order to determine beforehand the type of harvested material to be processed and, if applicable, other harvested material parameters and operating parameters, a dialog-based query may be performed. In so doing, the operator 33 may, for example, specify the type of harvested material. It is also contemplated to additionally query other parameters that may influence the wear of the chopping blades. For example, certain conditions, such as harvesting under sandy conditions, may be a parameter. With reference to the type of harvested material, a value for the relative cutting sharpness may be retrieved from the database saved in the memory unit 31 of the monitoring device 29. The harvested material parameters and operating parameters may be independently determined at least partially by sensor apparatuses available on the forage harvester 1, such as for example a position sensor or a forefield camera.

In one or some embodiments, after the virtual control field 34 is actuated to select the target state, precisely one indicator 39 or 40 is displayed next to the scale 35. In the example of the harvested material type “corn”, the indicator 39 is displayed, and in the example of the harvested material type “grass”, the indicator 40 is displayed.

If the operator 33 decides to manually enter the target state, a virtual control element 41 may be displayed by the input/output unit with which the target state may be manually selected. To do this, the virtual operating element 41 may be designed as a movable or rotatable controller. In the shown exemplary embodiment, the virtual control element 41 is designed as an arrow that may be moved virtually along the scale 35. Other ways in which to manually input the target state are contemplated.

Depending on the action of the operator 33 of manually entering the target state himself or herself using the control element 41, or selecting it by actuating the virtual control field 34, just one indicator 39 or 40, or the virtual control field 34, is displayed that indicates the entered or selected target state.

The monitoring device 29 generates, such as continuously, information depending on the target state and the determined state of wear, and the input/output unit 19 visualizes the extent to which the currently determined state of wear deviates from the target state. As already noted, a relative cutting sharpness and/or a number of grinding cycles to be performed is entered or selected as a target state for the chopping blades 8 that, after they are performed, a relative cutting sharpness entered or selected as the target state is achieved. In this case, the extent of the deviation of the current state of wear from the entered or selected target state is visualized as an operating parameter of the grinding device 17. In one or some embodiments, the total number of grinding cycles may be displayed as an operating parameter of the grinding device 17 by which the actual state differs from the target state. A number of grinding cycles to be performed by the grinding device 17 to achieve the entered or selected target state is therefore used as a measure of the deviation.

In one or some embodiments, the information visualized by the input/output unit 19 may be displayed as any one, any combination, or all of a numeric value, as a column, or as a progression over time in a separate display field 42.

In the simplest case, just one numeric value for the number of grinding cycles is displayed by the input/output unit 19 in the display field 42 that reproduces the deviation of the current actual state of the chopping blades 8 from the targets state. The display of the number of grinding cycles as a pure numerical value may have the advantage that it is a comparative yardstick known to the operator 33.

The amount displayed in the display field 42 may be a positive or negative number of cutting cycles that describe the difference between the current actual state and the selected or entered target state. Accordingly, a positive number of grinding cycles stands for an actual state of the chopping blades 8 that is better than the selected or entered target state. Correspondingly, a negative number of grinding cycles for a current actual state of the chopping blades 8 indicates the deviation from the target state, which also corresponds to the number of grinding cycles to be performed that, after they are performed, yields the target state of the chopping blades 8 selected or entered by the operator.

For example, the value “0” for the number of cutting cycles in the display field 42 indicate to the operator 33 that the target state has been reached or is pending.

A negative value “−10” for the number of grinding cycles indicates that the actual state of the chopping blades 8 is ten grinding cycles from the target state, i.e., the deviation is ten grinding cycles that need to be performed to restore to the target state of the chopping blades 8.

A negative value “−27” for the number of grinding cycles as a deviation indicates that the actual state of the chopping blades 8 is 27 grinding cycles from the target state.

A positive value “+5” for the number of grinding cycles as a deviation indicates that the actual state of the chopping blades 8 is five grinding cycles from the target state, wherein the positive number of grinding cycles expresses that the current actual state of the chopping blades 8 is five cycles better than the target state.

By using the input/output unit 19, the operator 33 may enter a target value for the number of grinding cycles to be performed that need to be executed to establish the selected or set target state. If for example the value “20” is entered as a target value for the number of grinding cycles to be performed, the operator 33 is made aware by a warning message generated by the monitoring device 29 that the actual state of the chopper blades 8 corresponds to a deviation with the value “−20”.

According to one example for depicting the functional sequence, the operator 33 specifies a cutting sharpness of 80% as a target state for the chopping blades 8. Moreover, the operator 33 specifies the value “30” as a target value for the number of grinding cycles to be performed to reach the target state.

During the chopping process, “−23” is displayed in the display field 42 as a deviation of the actual state from the target state. The deviation lies below the target value for the number of grinding cycles to be performed. If there is an interruption in this situation that for example arises from an interruption in the transport logistics, the operator 33 may cause the 23 grinding processes to be performed to restore the target state of the chopping blades 8, even though the target value of “−30” has not been reached. The amount of the deviation shown in the display field 42 as a number of grinding cycles is then “0”. The chopping process may be continued.

In contrast to the above-described procedure, the operator may cause 30 grinding processes to be performed so that an actual state of the cutting sharpness of the chopping blades 8 arises that lies above the target state. This is demonstrated to the operator in that the amount of the deviation as a number of grinding cycles shown in the display field number 42 is then “+7”.

If for example only 20 grinding processes are initiated by the operator instead of the required 23 grinding process, the target state is not reached. The resulting deviation of the achieved actual state is displayed in the display field 42 by the amount “−3” as a deviation in the number of grinding cycles. The chopping process may also be continued, however already with a deviation of three grinding cycles from the target state.

If the value “−30” is displayed in the display field 42 for the number of grinding cycles during the chopping process, the operator 33 may be informed by a warning that the set deviation of the actual state from the target state has been reached. Independent of the warning, the operator 33 may continue the chopping process, for example when the conclusion of the ongoing harvesting process is foreseeable over the short term. Correspondingly, there is a greater deviation at the end of the harvest process; for example, the field shows “−40” as a number of grinding cycles that need to be performed in order to restore the set target state starting from the current state of wear.

Further, it is intended that the foregoing detailed description be understood as an illustration of selected forms that the invention may take and not as a definition of the invention. It is only the following claims, including all equivalents, which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

Reference numbers

| | |
|---|---|
| 1 | Forage harvester |
| 2 | Driver's cab |
| 3 | Harvesting header |
| 4 | Infeed and prepress rollers |
| 5 | Harvested material flow |
| 6 | Chopping device |
| 7 | Cutterhead |
| 8 | Chopping blade |
| 9 | Cutting blade assembly |
| 9a | Right-side chopper blade assembly |
| 9b | Left-side chopper blade assembly |
| 10 | Infeed area |
| 11 | Shear bar |
| 12 | Cracker |
| 13 | Regrinding apparatus |
| 14 | Post-acceleration apparatus |
| 15 | Discharge chute |
| 16 | Discharge flap |
| 17 | Grinding device |
| 18 | Grindstone |
| 19 | Input/output unit |
| 20 | Rotational axis |
| 21 | Drum bottom |
| 22 | Drum rear wall |
| 23 | Sensor assembly |
| 23a | Sensor assembly |
| 23b | Sensor assembly |
| 24 | Cutting edge |
| 25 | Induction center |
| 26 | Exciter assembly |
| 27 | Pole arrangement |
| 28 | Control device |
| 29 | Monitoring device |
| 30 | Computing unit |
| 31 | Memory unit |
| 32 | Screen |
| 33 | Operator |
| 34 | Control field |
| 35 | Scale |
| 36 | Comparative picture |
| 37 | Comparative picture |
| 38 | Comparative picture |
| 39 | Indicator |
| 40 | Indicator |
| 41 | Control element |
| 42 | Display field |
| 43 | Control element |
| 44 | Processor |
| 45 | Memory |
| 46 | Optical detection device |

1. A method for determining whether to grind chopping blades of a chopping device of a self-propelled forage harvester, the method comprising:
entering or selecting, via at least one input unit, a target state of the chopping blades;
determining, by a monitoring device on the forage harvester, information indicative of a current state of wear of the chopping blades; and
outputting, via at least one output unit, a visualization of a deviation of the current state of wear of the chopping blades from the target state of the chopping blades.

2. The method of claim 1, wherein the monitoring device cyclically determines the information indicative of the current state of wear of the chopping blades; and
wherein one or both of a cutting sharpness or a number of grinding cycles to be performed is entered or selected as the target state for the chopping blades that, after performing the number of grinding cycles, achieve the cutting sharpness.

3. The method of claim 1, wherein an extent of the deviation of the current state of wear from the entered or selected target state is visualized as an operating parameter of a grinding device of the forage harvester.

4. The method of claim 1, wherein the at least one input unit displays at least one comparative value for the target state to be entered or selected.

5. The method of claim 4, wherein the at least one comparative value displayed comprises at least one of a cutting sharpness when the chopping blades are in a new state or a target state value adapted to a specific harvesting situation.

6. The method of claim 1, wherein the visualization of the deviation comprises a number of grinding cycles to be performed by a grinding device to achieve the entered or selected target state.

7. The method of claim 1, wherein the visualization of the deviation comprises displaying comparative pictures of the current state of wear of the chopping blades indicating a currently determined state of wear and a state of wear corresponding to the target state.

8. The method of claim 7, wherein the target state is entered or selected for one or both of a plurality of harvesting parameters or a plurality of machine parameters;
further comprising:
saving, in at least one memory, a respective target state correlated to a respective harvesting parameter or a respective machine parameter; and
specifying at least one harvesting parameter or at least one machine parameter;
wherein the comparative pictures displayed that reproduce the target state are selected from the at least one memory depending on the specifying of the at least one harvesting parameter and the at least one machine parameter.

9. The method of claim 7, further comprising recording, by an optical detection device, the comparative pictures indicative of the current state of wear.

10. The method of claim 7, wherein the at least one input unit and the at least one output unit comprise a touch-sensitive screen; and
further comprising, responsive to selecting a comparative picture by touching the touch-sensitive screen, switching from a window mode to a full image mode or vice versa.

11. The method of claim 1, wherein the at least one input unit displays a virtual control field through which the target state is manually selected.

12. The method of claim 1, wherein the at least one input unit displays a virtual control field through which the target state is manually entered.

13. The method of claim 1, wherein the visualization comprises one or more of a numeric value, a column, or a progression over time.

14. The method of claim 1, further comprising performing an authorization query before making an entry or selecting the target state of the chopping blades.

15. A self-propelled forage harvester comprising:
a chopping device comprising a cutterhead with chopping blades and a shear bar for comminuting harvested material;
at least one input unit;
at least one output unit; and
a monitoring device configured to:
receive an entry or a selection, via the at least one input unit, of a target state of the chopping blades;
determine information indicative of a current state of wear of the chopping blades; and
output, via the at least one output unit, a visualization of a deviation of the current state of wear of the chopping blades from the target state of the chopping blades.

16. The forage harvester of claim 15, wherein the monitoring device is configured to cyclically determine the information indicative of the current state of wear of the chopping blades; and
wherein the monitoring device is configured to receive one or both of a cutting sharpness or a number of grinding cycles to be performed as the target state for the chopping blades that, after performing the number of grinding cycles, achieve the cutting sharpness.

17. The forage harvester of claim 15, further comprising a grinding device; and
wherein the monitoring device is configured to output the visualization depicting an extent of the deviation of the current state of wear from the entered or selected target state as an operating parameter of the grinding device.

18. The forage harvester of claim 15, wherein the at least one input unit and the at least one output unit comprise a touch-sensitive screen; and
wherein the touch-sensitive screen is configured to display at least one comparative value for the target state to be entered or selected.

19. The forage harvester of claim 18, wherein the at least one comparative value displayed comprises at least one of a cutting sharpness when the chopping blades are in a new state or a target state value adapted to a specific harvesting situation.

20. The forage harvester of claim 15, wherein the monitoring device is configured to output, via the at least one output unit, the visualization of the deviation comprising a number of grinding cycles to be performed by a grinding device to achieve the entered or selected target state.
